(19) United States
(12) Patent Application Publication
(10) Pub. No.: US 2025/0386372 A1
(43) Pub. Date: Dec. 18, 2025

(54) ACCESS POINT SELECTION FOR TRANSMIT OPPORTUNITY SHARING

(71) Applicant: QUALCOMM Incorporated, San Diego, CA (US)

(72) Inventors: Sanket Sanjay KALAMKAR, San Diego, CA (US); Abhishek Pramod PATIL, San Diego, CA (US); Gaurang NAIK, San Diego, CA (US); Alfred ASTERJADHI, San Diego, CA (US); George CHERIAN, San Diego, CA (US); Giovanni CHISCI, San Diego, CA (US); Sherief HELWA, San Diego, CA (US); Sai Yiu Duncan HO, San Diego, CA (US)

(21) Appl. No.: 19/183,100

(22) Filed: Apr. 18, 2025

Related U.S. Application Data
(60) Provisional application No. 63/644,335, filed on May 8, 2024.

(51) Int. Cl. H04W 74/0816; H04W 74/06; H04W 74/08

(52) U.S. Cl. CPC H04W 74/0816; H04W 74/06; H04W 74/0875

(57) ABSTRACT

This disclosure provides methods, components, devices and systems for access point (AP) selection for transmit opportunity (TXOP) sharing. Some aspects more specifically relate to how a first AP may select APs to share a portion of a TXOP with. The first AP may perform medium access coordination with candidate APs, including polling candidate APs and receiving response frames. The response frames may indicate whether, for each responsive AP, the responsive AP is to participate in the TXOP sharing and, if so, information associated with traffic occurring during the TXOP. The first AP may select the APs to share the portion of the TXOP with according to the response frames. The first AP may transmit a frame including an indication to share the portion of the TXOP with the APs. The APs may, in accordance with receiving the frame, communicate during the portion of the TXOP.

### CROSS REFERENCES

The present application for patent claims benefit of U.S. Provisional Patent Application No. 63/644,335 by KALAMKAR et al., entitled “ACCESS POINT SELECTION FOR TRANSMIT OPPORTUNITY SHARING,” filed May 8, 2024, assigned to the assignee hereof, and expressly incorporated by reference in its entirety herein.

### TECHNICAL FIELD

This disclosure relates generally to wireless communication and, more specifically, to access point selection for transmit opportunity sharing.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

Some wireless communication systems may support multiple AP coordination schemes. In some examples, APs in proximity to each other (such as in a neighborhood) may establish an agreement to coordinate with each other, such as using the multiple AP coordination schemes. The coordination may relate to time, frequency, or spatial resources, or a combination thereof. The multiple AP coordination schemes may include coordinated-time division multiple access (C-TDMA), coordinated spatial reuse (CSR), coordinated beamforming (CBF), or coordinated-restricted target wake time (C-RTWT), among other examples. Multiple AP coordination schemes may support sharing of a transmit opportunity (TXOP). For example, an AP may obtain a TXOP and share a portion of the TXOP with one or more other APs. In some examples, the multiple AP coordination schemes may involve long-term negotiations between the APs participating in the multiple AP coordination scheme. For example, the APs may negotiate conditions and capabilities under which the multiple AP coordination scheme is to be performed. In other words, APs may exchange capabilities (such as types of coordination) and establish parameters for coordination (such as bandwidth, traffic priority, or traffic flows). In some examples, the parameters for coordination may be associated with the capabilities or environmental characteristics, including channel conditions, traffic conditions (such as expected traffic), or both. However, the AP that obtains the TXOP is able to share the portion of the TXOP with one or more other APs may not be aware of the needs of the one or more other APs.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a first wireless access point (AP). The method includes receiving information associated with a set of wireless communication devices including a second wireless AP of a set of multiple second wireless APs, the information indicating one or more conditions for medium access, performing, in accordance with obtaining a TXOP, a medium access coordination with a subset of the set of wireless communication devices, the subset of the set of wireless communication devices associated with the one or more conditions for medium access, and transmitting, to one or more selected wireless communication devices, a frame including an indication to share a portion of the transmit opportunity (TXOP) with the one or more selected wireless communication devices, the one or more selected wireless communication devices of the subset of the set of wireless communication devices.

Another innovative aspect of the subject matter described in this disclosure can be implemented in first wireless AP for wireless communication. The first wireless AP includes a processing system that includes processor circuitry and memory circuitry that stores code. The processing system may be configured to cause the first wireless AP to receive information associated with a set of wireless communication devices including a second wireless AP of a set of multiple second wireless APs, the information indicating one or more conditions for medium access, perform, in accordance with obtaining a TXOP, a medium access coordination with a subset of the set of wireless communication devices, the subset of the set of wireless communication devices associated with the one or more conditions for medium access, and transmit, to one or more selected wireless communication devices, a frame including an indication to share a portion of the TXOP with the one or more selected wireless communication devices, the one or more selected wireless communication devices of the subset of the set of wireless communication devices.

Another innovative aspect of the subject matter described in this disclosure can be implemented in another first wireless AP for wireless communication. The first wireless AP includes means for receiving information associated with a set of wireless communication devices including a second wireless AP of a set of multiple second wireless APs, the information indicating one or more conditions for medium access, means for performing, in accordance with obtaining a TXOP, a medium access coordination with a subset of the set of wireless communication devices, the subset of the set of wireless communication devices associated with the one or more conditions for medium access, and means for transmitting, to one or more selected wireless communication devices, a frame including an indication to share a portion of the TXOP with the one or more selected wireless communication devices, the one or more selected wireless communication devices of the subset of the set of wireless communication devices.

Another innovative aspect of the subject matter described in this disclosure can be implemented in a non-transitory computer-readable medium storing code for wireless communication. The code includes instructions executable by one or more processors to receive information associated with a set of wireless communication devices including a second wireless AP of a set of multiple second wireless APs, the information indicating one or more conditions for medium access, perform, in accordance with obtaining a TXOP, a medium access coordination with a subset of the set of wireless communication devices, the subset of the set of wireless communication devices associated with the one or more conditions for medium access, and transmit, to one or more selected wireless communication devices, a frame including an indication to share a portion of the TXOP with the one or more selected wireless communication devices, the one or more selected wireless communication devices of the subset of the set of wireless communication devices.

In some examples of the method, first wireless APs, and non-transitory computer-readable medium described herein, the one or more conditions include an expected traffic arrival, one or more negotiated epochs in time, a wake state of an associated wireless communication device, an indication in a beacon or broadcast frame of a neighboring wireless communication device, or any combination thereof.

In some examples of the method, first wireless APs, and non-transitory computer-readable medium described herein, performing the medium access coordination may include operations, features, means, or instructions for transmitting, during the TXOP, a polling frame and receiving a response frame from at least one wireless communication device of the subset of the set of wireless communication devices, where the response frame indicates one or more conditions associated with whether the at least one wireless communication device may be to participate in sharing of the portion of the TXOP.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communication between a wireless access point (AP) and one or more wireless stations (STAs).

FIG. 3 shows an example physical layer (PHY) protocol data unit (PPDU) usable for communication between a wireless AP and one or more wireless STAs.

FIG. 4 shows a hierarchical format of an example PPDU usable for communication between a wireless AP and one or more wireless STAs.

FIG. 5 shows an example of a wireless communication system that supports AP selection for transmit opportunity (TXOP) sharing.

FIG. 6 shows an example of wireless communication that supports AP selection for TXOP sharing.

FIG. 7 shows an example of wireless communication that supports AP selection for TXOP sharing.

FIG. 8 shows an example of information shared by wireless communication devices during an agreement phase or negotiation that supports AP selection for TXOP sharing.

FIG. 9 shows an example of a process flow that supports AP selection for TXOP sharing.

FIG. 10 shows a block diagram of an example wireless communication device that supports AP selection for TXOP sharing.

FIGS. 11 through 14 show flowcharts illustrating example processes performable by or at a first wireless AP that supports AP selection for TXOP sharing.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Various aspects relate generally to transmit opportunity (TXOP) sharing according to which a first wireless communication device may share a portion (such as at least a subset of) of a TXOP with one or more second wireless communication devices. Some aspects more specifically relate to how the first wireless communication device may select the one or more second wireless communication devices to share the portion of the TXOP with. For example, the first wireless communication device, which may be an example of an access point (AP), may determine a subset of candidate wireless communication devices from a set of candidate wireless communication devices to perform a medium access coordination with. In some examples, the first wireless communication device may determine the subset of candidate wireless communication devices based on information received via, as an example, long-term negotiations between wireless communication devices (such as APs and/or STAs) participating in a coordination scheme. As an example, wireless communication devices of the subset may have expected traffic arrivals within a threshold duration of a start of the TXOP. The medium access coordination may involve polling (such as transmitting polling frames to) the subset of the candidate wireless communication devices having expected traffic arrivals within a threshold duration of a start of the TXOP. In response to the polling, the subset of the candidate wireless communication devices may transmit response frames. The response frames may indicate whether, for each responsive wireless communication device, the responsive wireless communication device is to participate in the TXOP sharing and, if so, information associated with traffic occurring during the TXOP (such as an amount of buffered traffic, time-to-live (TTL) of low-latency traffic). As an example, a wireless communication device of the subset may indicate information via encoding associated with a response size below a threshold. In examples in which the threshold is 4 bits, a response of 0000 may indicate a lack of intent to participate, 0001 may indicate a first range of buffer sizes (such as 1-100 bytes), 0010 may indicate a second range of buffer sizes (such as 101-200 bytes), and so on. Additionally, or alternatively, the different responses may be associated with TTL ranges (such as a first range of 1-2 ms, a second range of 5-10 ms, and so on). The first wireless communication device may select one or more second wireless communication devices to share the portion of the TXOP with according to the response frames. For example, the first wireless communication device may select a candidate wireless communication device according to an amount of buffered traffic, or a priority level of buffered traffic, among other examples, at the candidate wireless communication device. The first wireless communication device may transmit a frame including an indication to share the portion of the TXOP with the one or more second wireless communication devices. The one or more second wireless communication devices may, in accordance with receiving the frame, communicate during the portion of the TXOP.

Particular aspects of the subject matter in this disclosure can be implemented to realize one or more of the following potential advantages. By polling the subset of the set of candidate wireless communication devices, the first wireless communication device may use fewer resources compared to polling the full set of candidate wireless communication devices (such as all wireless communication devices). For example, the first wireless communication device may poll candidate wireless communication devices according to a set of resources (such as time resources, frequency resources, or both) allocated to polling. Polling the subset of the set of candidate wireless communication devices, rather than the full set of candidate wireless communication devices, may enable the first wireless communication device to perform the polling without exceeding the set of resources while also receiving the information needed. Additionally, or alternatively, by polling the subset of the set of candidate wireless communication devices, the first wireless communication device may reduce processing overhead. For example, candidate wireless communication devices which do not have expected traffic arrivals within a threshold duration of a start of the TXOP may be excluded from the subset, and, accordingly, may not receive and/or process a polling message. In some examples, by selecting the one or more second wireless communication devices based on responses to the polling including the information associated with traffic at candidate wireless communication devices during the TXOP, the first wireless communication device may share the portion of the TXOP with one or more candidate wireless communication devices having traffic in the TXOP with a higher level of accuracy compared to sharing the portion of the TXOP based on other information, such as information associated with long-term negotiations. For example, the information shared via the responses to the polling may have a higher level of accuracy related to traffic predictions compared to a level of accuracy associated with traffic information communicated during the long-term negotiations, which may be associated with a long-term schedule at a candidate wireless communication device.

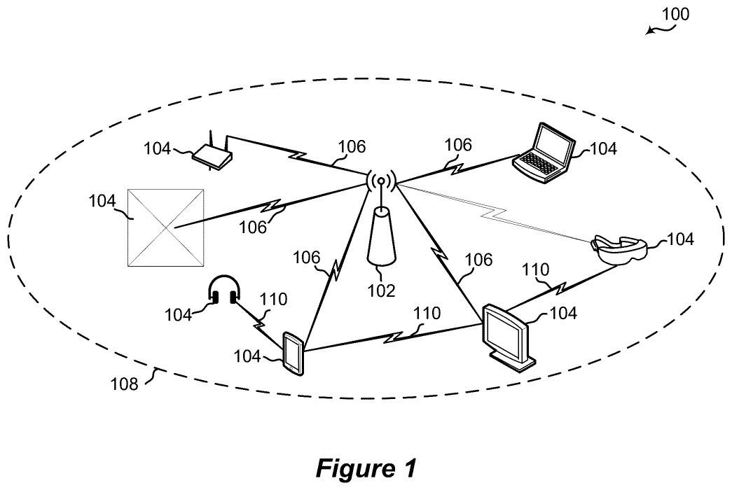

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communication (hereinafter also referred to as “Wi-Fi communication” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communication. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communication or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communication spanning operating bandwidths of 20 MHz, 40 MHz, 80 MHz, 160 MHz, 240 MHz, and 320 MHz while an UHR system may enable communication spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

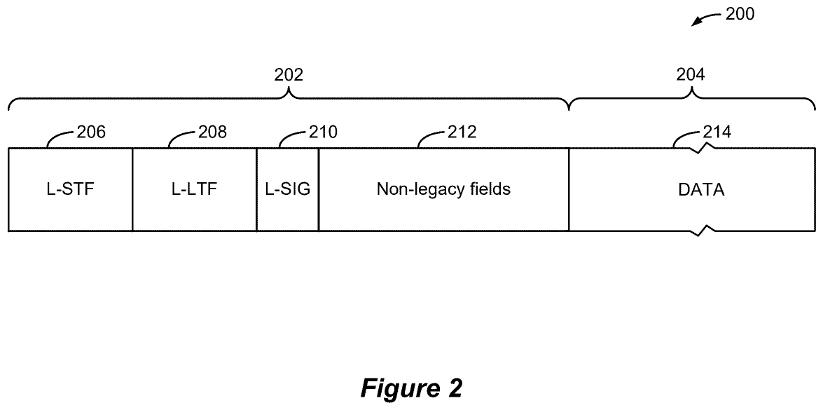

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

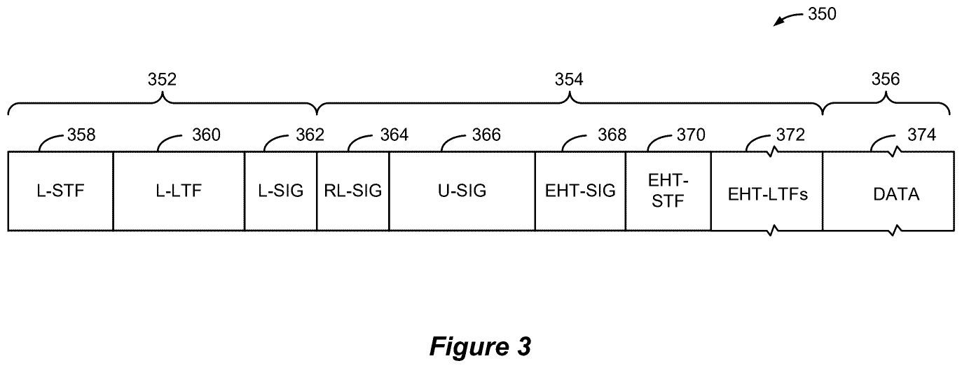

FIG. 3 shows an example physical layer (PHY) protocol data unit (PPDU) 350 usable for communication between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as an AP 102 or a STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

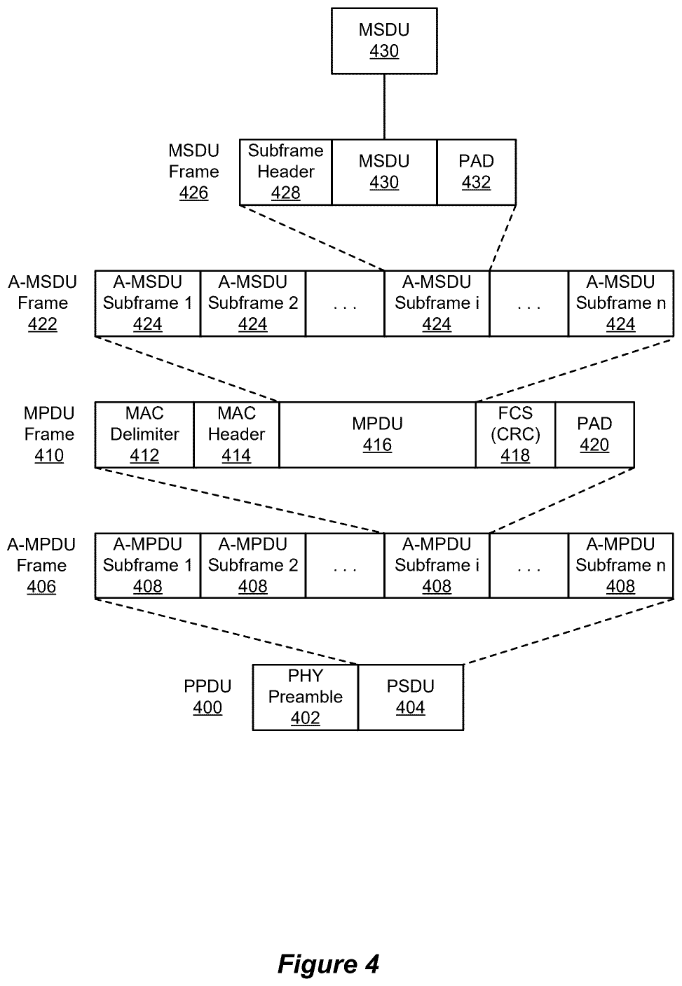

FIG. 4 shows a hierarchical format of an example PPDU usable for communication between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a TXOP and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communication with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communication among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse polling frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communication networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QOS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as AP 102s and STA 104s) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communication. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

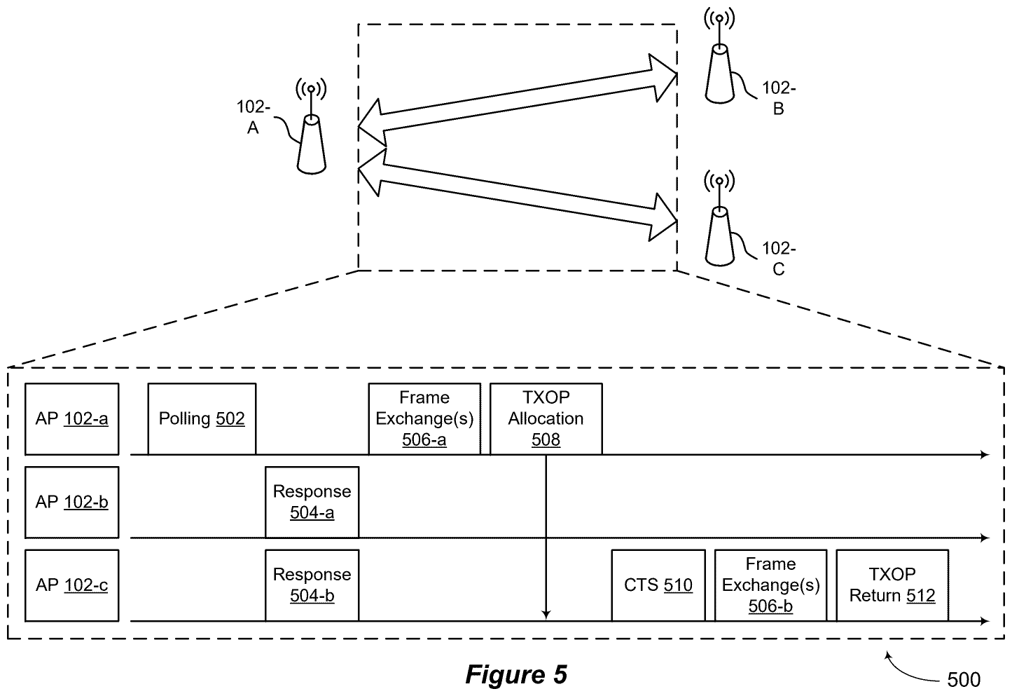

FIG. 5 shows an example of a wireless communication system 500 that supports AP selection for TXOP sharing. The wireless communication system 500 may implement or be implemented to realize one or more aspects of the wireless communication network 100, the PDU 200, the PPDU 350, or any combination thereof. For example, the wireless communication system 500 illustrates communication between an AP 102-a, an AP 102-b, and an AP, which may be examples of the AP 102 as illustrated by and described with reference to FIG. 1.

The wireless communication system 500 may support a multiple-AP coordination scheme. Multiple-AP coordination schemes may include coordinated-time division multiple access (C-TDMA), coordinated spatial reuse (CSR), coordinated beamforming (CBF), coordinated-restricted target wake time (C-RTWT), or the like. In the example of FIG. 5, the AP 102-a may share a portion of an obtained TXOP (such as a TXOP “owned” by the AP 102-a) with one or more other APs, such as the AP 102-b and/or the AP 102-c. In some examples, such as in examples in which the multiple-AP coordination scheme includes C-TDMA, the wireless communication system 500 may support improved latency and reduced contention and/or collisions (such as by sharing TXOPs). In some examples, the multiple-AP coordination scheme may involve negotiations, such as long-term negotiations, between participating APs, including the AP 102-a, the AP 102-b, and the AP 102-c. For example, the APs 102 may negotiate conditions and capabilities under which the multiple-AP coordination scheme is to be performed.

In some aspects, the AP 102-a, which may be an example of a sharing AP (such as that won a TXOP), may not be aware of long-term conditions (such as needs, requirements) of the AP 102-b and/or the AP 102-c, which may be examples of candidate shared APs, such as conditions associated with resources (such as resource requirements), traffic (such as traffic requirements), and/or latency (such as latency requirements). Additionally, in examples in which the AP 102-a is aware of the long-term conditions of the AP 102-b and/or the AP 102-c, short-term conditions, such as conditions associated with the TXOP (such as a current TXOP) may be different than the long-term conditions. In other words, the AP 102-b and/or the AP 102-c may have different conditions associated with resources and/or latency during the TXOP (such as in the short term) than in the long-term. To identify conditions of the AP 102-b and/or the AP 102-c during the TXOP, the AP 102-a may poll the AP 102-b and/or the AP 102-c at a start of the TXOP. For example, the AP 102-a may select an AP to share the TXOP with based on the short-term conditions at the AP 102-b and/or the AP 102-c for the current TXOP (such as rather than long-term conditions). In some examples, the AP 102-a may determine which APs 102 to poll according to information associated with the long-term conditions of the AP 102-b and/or the AP 102-c. For example, the AP 102-a may use the long-term conditions to identify APs 102 for polling, TXOP sharing, or both.

A sequence of multiple-AP coordination scheme (such as C-TDMA) may include an agreement phase, a polling phase, a TXOP sharing phase, and/or a TXOP return phase. The agreement phase may involve the negotiation between APs 102, such as long-term negotiations. The polling phase, the TXOP sharing phase, and/or the TXOP return phase may involve a TXOP-level. In other words, the polling phase, the TXOP sharing phase, and/or the TXOP return phase may be related to a TXOP, such as in the short-term. The polling phase may involve the AP 102-a transmitting a polling frame 502. For example, the AP 102-a may poll candidate APs 102, such as the AP 102-b and/or the AP 102-c. In some examples, the AP 102-a may transmit the polling frame 502 during the TXOP, such as at a start of the TXOP. The polling frame 502 may solicit responses from candidate APs. In other words, the AP 102-a may poll candidate shared APs 102, such as the AP 102-b and/or the AP 102-c, to identify APs that may use TXOP sharing (such as APs needing a TXOP) and check an interest of the candidate shared APs to participate in TXOP sharing. Additionally, or alternatively, the polling frame 502 may poll in-BSS STAs of the AP 102-a.

For example, the AP 102-b and the AP 102-c may respond to the polling frame 502 via a response frame 504-a and a response frame 504-b, respectively. In some aspects, the AP 102-b and/or the AP 102-c may identify a traffic priority for which the shared TXOP is to be used. For example, according to an agreement (such as of the agreement phase), the AP 102-b and/or the AP 102-c may serve traffic with a same or higher access category for which the TXOP was won. The traffic priority may be in accordance with a traffic identifier, a stream classification service (SCS) identification (SCSID), or both.

In the example of FIG. 5, the response frame 504-a may indicate a negative response, such as a lack of interest in sharing the TXOP. For example, the AP 102-b may opt out of TXOP sharing according to a traffic category of the TXOP, an access category of traffic of the AP 102-b relative to the TXOP (such as the traffic having a lower access category than the TXOP), or the like. In some examples, the AP 102-b may refrain from transmitting the response frame 504-a based on opting out of TXOP sharing. Alternatively, the response frame 504-b may indicate a positive response, such as an interest in sharing the TXOP. For example, the AP 102-c may identify one or more clients, such as associated STAs, to serve during the TXOP according to a traffic priority associated with the TXOP. The response frame 504-b, in addition to indicating an interest in sharing the TXOP, may indicate additional information. For example, the response frame 504-b may indicate an amount (such as a BSS aggregate) of buffered traffic at the AP 102-c, a TTL of low-latency traffic, or the like.

After receiving the response frame 504-a and/or the response frame 504-b, the AP 102-a may perform frame exchange(s) 506-a with one or more STAs associated with the AP 102-a. According to the response frame 504-b indicating interesting in sharing the TXOP, the AP 102-a may select the AP 102-c for TXOP sharing and transmit a TXOP allocation 508 to the AP 102-c. The TXOP allocation 508 may be an example of an MU-request to send (RTS) transmit sharing (TXS) message. The TXOP allocation 508 may trigger TXOP sharing with the AP 102-c. The AP 102-c may transmit a CTS 510 in response to the TXOP allocation 508. In some examples, the AP 102-c may perform frame exchange(s) 506-b with one or more STAs associated with the AP 102-c. For example, the AP 102-c may communicate with the one or more STAs via the shared TXOP, such as according to the TXOP allocation 508. The AP 102-c may, after performing the frame exchange(s) 506-b, transmit a TXOP return frame 512 to the AP 102-a. For example, the AP 102-a may reclaim unused TXOP (such as if any) from the AP 102-c via the TXOP return frame 512.

In some examples described herein, the APs 102 may communicate the polling frame 502, the response frame 504-a and/or the response frame 504-b, or both according to a polling scheme and/or polling parameters. For example, the AP 102-a may transmit the polling frame 502 at a start of the TXOP. As an example, the AP 102-a may transmit the polling frame 502 at the start of the TXOP to determine a schedule for the obtained TXOP, including whether the TXOP is to be shared with the AP 102-b and/or the AP 102-c (such as or to be used for serving in-BSS STAs), which AP the TXOP is to be shared with, or both. The AP 102-a may determine the schedule for the obtained TXOP in accordance with the response frame 504-a and/or the response frame 504-b.

During negotiation (such as or renegotiation), the AP 102-a, the AP 102-b, and/or the AP 102-c may agree on a polling scheme and/or parameters for polling. For example, in examples in which the wireless communication system 500 supports multiple polling schemes, the APs 102 may negotiate (such as or renegotiate) which polling schemes are supported by participating APs. In other words, the AP 102-a (such as the sharing AP) may determine the polling scheme according to which polling schemes are supported by the AP 102-b and/or the AP 102-c. As an example, the AP 102-b may not support a TB PPDU response format, and, accordingly, may not support buffer status report polling (BSRP). Additionally, or alternatively, for each polling scheme, the APs 102 may negotiate associated polling parameters, including a type of response, a format of the response, setting of fields within the poll and/or response (such as to encode information), or any combination thereof. For example, the APs 102 may agree that a first value within a field indicates interest or disinterest to use a shared portion of the TXOP. As another example, a set of address values may be encoded to represent different ranges of traffic buffers, TTL for buffered traffic, or both.

In some implementations, the AP 102-b and/or the AP 102-c may provide information associated with a processing duration, a response duration, or both. For example, the AP 102-b and/or the AP 102-c may indicate processing and/or response durations associated with different polling schemes. As an example, for BSRP, which may be associated with a trigger-based response, the AP 102-b and/or the AP 102-c may be associated with a relatively long processing and/or response durations. Alternatively, for MU-RTS, which may be associated with a CTS response, the AP 102-b and/or the AP 102-c may be associated with relatively short processing and/or response durations. The AP 102-b and/or the AP 102-c may provide the information associated with the processing and/or response durations during negotiation or advertise the information (such as via a beacon frame or broadcast frame). The AP 102-a may poll the AP 102-b and/or the AP 102-c according to the information. For example, the AP 102-a may organize a user information field in the polling frame 502 or add padding such that a responding AP (such as the AP 102-b or the AP 102-c) has sufficient time to process and prepare a response. As an example, for a polling scheme in which the AP 102-b and/or the AP 102-c respond simultaneously in short inter-frame spacing (such as are separated in a frequency domain), the AP 102-a may determine a user information field such that a sum of the SIFS and a duration until an end of the polling frame is greater than an indicated processing duration. As another example, for a polling scheme in which the AP 102-b and/or the AP 102-c respond in TDM fashion (such as one after the other in a time domain, SIFS separated), the AP 102-a may determine a user information field such that a sum of the SIFS, a duration until the end of the polling frame, and a duration of prior responses and associated SIFS is greater than the indicated processing duration.

In some examples, the polling scheme may involve a polling frame which solicits a first type of response. For example, the first type of response may be a trigger-based response. Additionally, or alternatively, the polling scheme may be BSRP. The BSRP may involve the AP 102-a polling in-BSS (such as STAs) and candidate APs, including the AP 102-b and/or the AP 102-c, to determine whether the wireless communication devices are to participate. For example, the AP 102-a may transmit the polling frame 502 during the TXOP. In some implementations, the AP 102-a may transmit the polling frame 502 to determine an amount of pending traffic at the wireless communication devices. Additionally, or alternatively, the BSRP may involve the AP 102-b and/or the AP 102-c responding to the polling frame 502 in a trigger-based PPDU. In other words, the response frame 504-a and/or the response frame 504-b may be examples of trigger-based PPDUs. In some examples, the polling scheme may involve the AP 102-b and/or the AP 102-c being in a first state (such as unassociated APs, in an unassociated state). The AP 102-b and/or the AP 102-c may transmit the response frame 504-a and/or the response frame 504-b of the first type of response (such as the trigger-based response, trigger-based PPDU, etc.) in accordance with the AP 102-b and/or the AP 102-c being associated with one or more conditions. For example, the one or more conditions may satisfy a threshold associated with transmission of the first type of response.

In some other implementations, the polling scheme may involve a polling frame which solicits a short response, which may be an extension of or similar to null data packet (NDP) feedback report polling (NFRP). In such implementations, multiple poll questions may be defined. For example, different poll questions may be defined for different agreements. In other words, the poll questions may be defined by the AP 102-a, the AP 102-b, and/or the AP 102-c during the negotiation. Some examples of poll questions may include “do you want to participate in sharing?”; “do you have buffers greater than X bytes (for a threshold traffic identifier)?”; “do you have any pending low-latency traffic that has a TTL less than Y microseconds?”; and so on. The poll questions may be different for different sharing APs. That is, in the example of FIG. 5, the AP 102-a is the sharing AP, but in a different example, such as in an example in which the AP 102-b is the sharing AP, the AP 102-b may have a different set of polling questions than the AP 102-a. Additionally, or alternatively, polling questions may involve the AP 102-b and/or the AP 102-c responding to the polling frame 502 in a trigger-based PPDU. The response frame 504-a and the response frame 504-b may include short responses. For example, the responses may be binary (such as yes or no), equal to or less than an octet (such as eight bits), or both.

In another implementation, the polling scheme may involve a mechanism that does not involve a trigger based response. For example, the polling scheme may be MU-RTS, which may involve a CTS in a non-trigger based PPDU as a response. In some examples, the AP 102-a may solicit a response from the AP 102-b and the AP 102-c in distinct subbands or subchannels (such as 20 MHz subchannels). For example, the AP 102-b may transmit the response frame 504-a, which may be a CTS, in a subchannel or subband designated for the AP 102-b, while the AP 102-c may transmit the response frame 504-b in a different subchannel or subband designated for the AP 102-c. The AP 102-a may identify a responder according to the subchannel or subband. In some examples, a presence or absence of a response, such as the CTS, from an AP may indicate an interest or disinterest to use the shared TXOP. For example, the AP 102-b may refrain from transmitting the CTS to indicate disinterest in using the TXOP, while the AP 102-c may transmit the CTS to indicate interest in using the TXOP. Additionally, or alternatively, the AP 102-b and/or the AP 102-c may include additional information in the CTS, such as in a service field. For example, the additional information may be associated with a buffer at the AP 102-b and/or the AP 102-c. In such examples, the AP 102-a may designate alternating subchannels as empty (such as to reduce interference). For example, for a 320 MHz bandwidth, the AP 102-a may solicit responses to the polling frame 502 from 4 clients, where 20 MHz channels of the 320 MHz bandwidth are associated with different clients or are empty in an alternating manner.

In some examples, the response frame 504-a and the response frame 504-b may be separated in a time domain. For example, the AP 102-a may transmit the polling frame 502, which may be an example of an ICF or a block ack request (BAR) frame, and which solicits responses separated in the time domain. In some examples, the AP 102-a may transmit the polling frame 502 to poll the AP 102-b and/or the AP 102-c, in-BSS STAs, or both. The AP 102-a may receive responses from different responders, such as from the AP 102-b and/or the AP 102-c, at different times, such as spaced in time (such as one after the other and SIFS separated). For example, the polling frame 502 may indicate respective times at which different APs may respond. In some examples, an AP may not respond to the polling frame 502 in accordance with lack of interest in participating in the TXOP sharing. Alternatively, other APs may respond to the polling frame 502 in accordance with an interest in participating in the TXOP sharing (such as despite a preceding AP not responding). The AP 102-a may set a duration of a network allocation vector (NAV) in accordance with an end of a last expected response such that other APs or in-BSS STAs do not occupy the medium if an AP does not respond. In some examples, the AP 102-b and/or the AP 12-c may include information in a field (such as a service field) of the response frame 504-a or the response frame 504-b, respectively, which may be examples of CTS responses.

In some examples, the AP 102-b and/or the AP 102-c may set a receiver address (RA) of the response frame 504-a or the response frame 504-b, respectively, in accordance with an interest to participate in the TXOP sharing. That is, a responding AP may not set a RA of a response frame to a MAC address of a soliciting AP (such as the AP 102-a). Rather, the responding AP may set the RA to a value of a set of values representative of different encoding. As an example, a first address may represent no interest to participate, a second address may indicate a buffer of a first size (such as 1-100 bytes), a third address may indicate a buffer of a second size (such as 101-200 bytes), and so on. In some examples, the responding AP may set the RA of the response frame to an address of the soliciting AP. For example, the RA of the soliciting AP may indicate that the responding AP does not intend to participate, or does intend to participate and additionally indicates information associated with buffered traffic (such as a size or TTL). Additionally, or alternatively, the encoding may represent a TTL or other characteristics of the traffic. In other words, the RA of the response may represent encoding of a feature or parameter. In some examples, setting a RA to indicate a feature or parameter in a response may be applied to one or more coordination schemes, for features involving in-BSS STAs, or both. That is, RAs in response frames may represent information. For example, different RAs may be included in response frames as an indication of information associated with the responder.

In some examples, the response frame 504-a and/or the response frame 504-b may be QoS null frames, management frames, or the like. Additionally, or alternatively, the polling frame 502 may be an example of a BSRP frame. For example, the response frame 504-a and/or the response frame 504-b may be the QoS null frames including resource request information, such as embedded in a higher throughput (HT) control field (such as an A-control field) or in a field in a QoS control field (such as a queue size field). Alternatively, the response frame 504-a and/or the response frame 504-b may be the management frames including resource request information embedded in the HT control field (such as the A-control field). In some examples, a management frame may be an example of an action frame for multiple AP coordination or a public action frame. Additionally, or alternatively, a payload of the management frame may be zero (in other words, a frame body may be absent). The A-control field in the QoS null frame or the management frame may provide resource information and, in some examples, may be included in a BSRP. The A-control field may include information such as a bandwidth-time product, aggregate buffer information (such as bytes), TTL information, or a combination thereof.

In examples in which the response frame 504-a and/or the response frame 504-b are the QoS null frames or management frames, the AP 102-b or the AP 102-c, respectively, may transmit the respective response frames according to a set of rules, such as rules associated with not soliciting an immediate control response. As an example, an ACK policy field in a QoS control field may be set to BlockAck or No Ack in the example of the QoS null frame. Alternatively, in the example of the management frame, the management frame may be of a type action No Ack. The AP 102-b and/or the AP 102-c (such as unassociated APs, in an unassociated state) may transmit the response frames as QoS null frames or management frame according to the response frames including a field, such as an A-control field in an HT control field.

In some examples, the polling frame 502 may be an example of a multi-user block ack request (MU-BAR), while the response frame 504-a and/or the response frame 504-b may be examples of multi-STA block acks (M-BA). For example, the MU-BAR may support solicitation of the BAs from more than one device. In some examples, the MU-BAR may include a value (such as a predefined value) indicating that the MU-BAR is a polling frame for soliciting participation and/or buffer information from candidate APs, in-BSS STAs, or both. In such examples, the response frame 504-a and/or the response frame 504-b may be the M-BA frame that includes information, such as buffer information or an intent to participate in TXOP sharing, encoded in a predefined format. One or more fields in a frame may be indicative of one or more conditions associated with TXOP sharing. For example, the one or more fields may include a value associated with performance of TXOP sharing by a device transmitting the frame. A per association ID traffic ID information field (such as per AID TID field) may include an AID value indicative of TXOP sharing. Such an AID value may be predefined or be agreed as part of the coordination agreement. The soliciting BAR frame may include a value in a field (such as the TID field or within a reserved field, such as the reserved field in the Per-TID Info field of the multi-TID BAR variant) to indicate that it is a polling frame.

In some examples, an AP may provide a resource request (in other words, pending buffer size, or TTL or bandwidth-time product) in an unsolicited manner. For example, the AP 102-b and/or the AP 102-c may transmit the QoS null frame of an action frame (such as public action frame) to a broadcast address, a group address (such as predefined or determined via negotiation), or to an address of a neighboring AP with whom the AP 102-b and/or the AP 102-c are coordinating (such as the AP 102-a).

In some examples, the APs 102 may perform TXOP sharing according to one or more negotiated time durations, such as time durations designated for TXOP sharing. As an example, the AP 102-a, the AP 102-b, and the AP 102-c may agree on one or more service periods or epochs associated with TXOP sharing (such as in examples in which TXOP sharing is allowed, permitted) and an AP that wins the TXOP during the one or more service period or after the epoch, such as the AP 102-a, may poll the participating APs, such as the AP 102-b and/or the AP 102-c, to determine which APs are interested in TXOP sharing.

In some other examples, a criterion associated with polling may be according to trigger points. For example, a beacon frame of a neighboring AP, such as the AP 102-b or the AP 102-c, may include an indication that the neighboring AP is interested in sharing. In some examples, the neighboring AP may transmit the beacon frame in accordance with a client device of the neighboring AP, an aperiodic traffic or SCS flow, transitioning out of a power-save state, or the like. In accordance with the beacon frame including the indication, the AP 102-a may poll the neighboring AP after obtaining a TXOP.

In some aspects, criteria selection of APs for polling also may be applied directly to the TXOP allocation phase. For example, in examples in which there is no polling at the start of a TXOP, the AP 102-a (such as the sharing AP) may still select APs (such as appropriate APs) to allocate the shared TXOP to. For example, the AP 102-a may select candidate AP(s) having expected traffic arrival is around the time of a TXOP allocation frame. As an example, the AP 102-a may select a candidate AP having traffic closest to the TXOP allocation frame relative to other candidate APs. Additionally, or alternatively, polling criteria may be used to select APs for TXOP sharing during the TXOP allocation phase.

In some scenarios, the AP 102-a may not share the TXOP with the polled APs (such as all polled APs), APs which provided a response indicating interest to participate, or both. For example, the AP 102-a may select a quantity of APs to share the TXOP with based on a criteria, such as single AP sharing, a size of a pending TXOP, or the like.

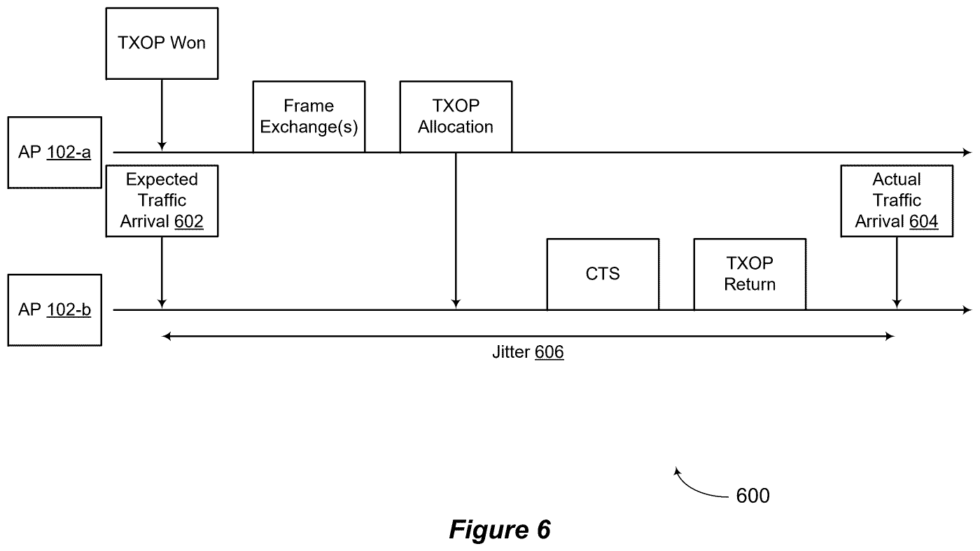

FIG. 6 shows an example of wireless communication 600 that supports AP selection for TXOP sharing.

The wireless communication 600 of FIG. 6 may implement or be implemented to realize one or more aspects of the wireless communication network 100, the PDU 200, the PPDU 350, the wireless communication system 500, or any combination thereof. For example, the wireless communication 600 may be between an AP 102-a and an AP 102-b, which may be examples of the AP 102 as illustrated by and described with reference to FIGS. 1 and 5.

In the example of FIG. 6, the AP 102-a may select the AP 102-b for TXOP sharing according to an expected traffic arrival 602 at the AP 102-b (such as or other information). Information associated with the expected traffic arrival 602 may be shared with the AP 102-a via negotiations (such as long-term negotiations, SCS), such as negotiations associated with a multiple AP coordination scheme. However, in some examples, the expected traffic arrival 602 associated with the negotiations may have a low level of accuracy relative to, as an example, information obtained or received via polling. For example, there may be variation in the expected traffic arrival 602 versus the actual traffic arrival 604, which may be due to jitter 606 and/or other conditions at the AP 102-b. In other words, traffic conditions (such as short-term requirements) at the AP 102-b during a TXOP (such as a current TXOP) may be different than conditions (such as long-term requirements) shared during the negotiation (such as long-term agreements). As an example, the conditions shared during the negotiation may not include a TTL for a low-latency packet at the AP 102-b. The AP 102-a may, to accommodate for variation in the arrival of actual traffic at candidate shared APs, poll the candidate shared APs to check for an existence of traffic in a TXOP.

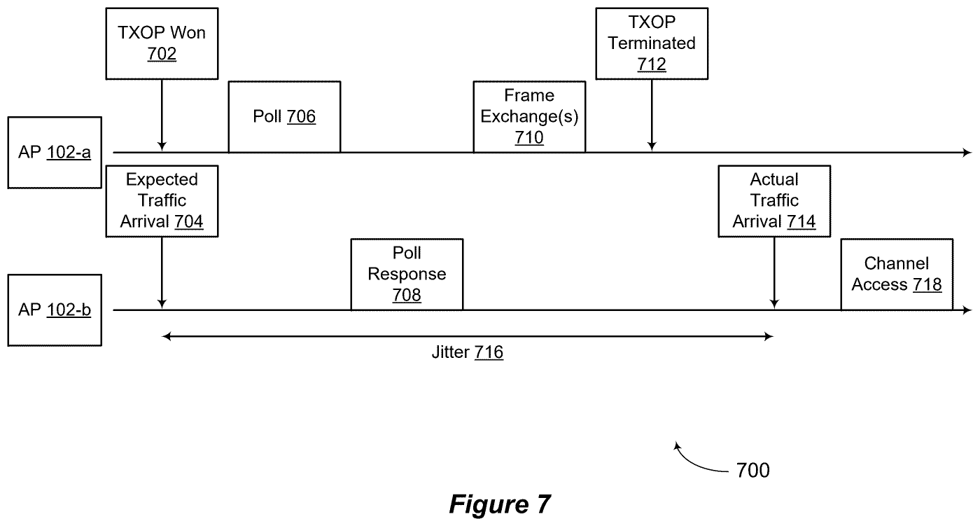

FIG. 7 shows an example of wireless communication 700 that supports AP selection for TXOP sharing.

The wireless communication 700 of FIG. 7 may implement or be implemented to realize one or more aspects of the wireless communication network 100, the PDU 200, the PPDU 350, the wireless communication system 500, or any combination thereof. For example, the wireless communication 700 may be between an AP 102-a and an AP 102-b, which may be examples of the AP 102 as illustrated by and described with reference to FIGS. 1 and 5.

The AP 102-a may win a TXOP 702. For example, the AP 102-a may obtain a TXOP. In some examples, the AP 102-a may determine to share the TXOP. For example, the AP 102-a may determine whether to share the TXOP according to one or more factors, such as an amount of in-BSS traffic, a length of the TXOP, expected traffic at candidate APs (such as including the AP 102-b), or any combination thereof. In some examples, conditions under which the TXOP may be shared may be determined according to negotiations (such as long term negotiations) between the AP 102-a and the AP 102-b, behavior of APs 102, or both. For example, the behavior of the APs 102 may include how frequently the AP 102-b shared an obtained TXOP during TXOPs occurring prior to the TXOP in the example of FIG. 7. In some examples, the AP 102-a may poll the AP 102-b (such as candidate shared APs) to gather information irrespective of whether the AP 102-a is to share the TXOP. For example, the AP 102-a may poll the AP 102-b prior to determining whether to share the TXOP, and, in some examples, may determine to share the TXOP according to information obtained or received via polling the AP 102-b. The AP 102-a may refrain from transmitting a poll frame 706 after obtaining the TXOP. For example, the AP 102-a may not send, such as may refrain from transmitting, a poll in the obtained TXOP. In some examples, the AP 102-a may transmit a poll frame 706 in accordance with determining to share the TXOP. For example, the AP 102-a may determine to share the TXOP prior to transmitting the poll frame 706. In some examples, the poll frame may not carry traffic priority information. A shared AP (such as the AP 102-b) may be aware of (such as know) one or more traffic flows which may be served during the shared portion of the TXOP. For example, information associated with which traffic flows may be served during the shared portion of the TXOP may be in accordance with a traffic priority or one or more other criteria or parameters, such as criteria or parameters agreed to between the AP 102-a and the AP 102-b, such as APs in a multi-AP coordination scheme. The AP 102-a and the AP 102-b may agree to the criteria or parameters during setup or negotiation of the multi-AP coordination scheme, such as during C-TDMA setup or negotiation.

In examples in which the AP 102-a determines to share the TXOP, the AP 102-a may share the TXOP with an AP having a greatest need relative to other candidate APs. For example, the AP 102-a may select the AP 102-b to share the TXOP with according to criteria (such as rather than blindly). The AP 102-a may poll candidate APs to gather information associated with traffic occurring during the TXOP. In such examples, the AP 102-a may poll a subset of the candidate APs. For example, the AP 102-a may poll the subset, rather than the set, of candidate APs to conserve resources (such as time and/or frequency) available for polling, reduce processing at the AP 102-a and polled APs, or both. As an example, the AP 102-a may select a quantity of candidate APs to poll in accordance with satisfying a threshold quantity of resource units.

In some examples, the AP 102-a may poll one or more candidate APs having expected traffic arrivals within a threshold duration of a start of the TXOP, such as a won TXOP 702. For example, the AP 102-a may transmit a poll frame 706 to the AP 102-b, the AP 102-b having the expected traffic arrival within the threshold duration of the start of the TXOP. In some examples, the AP 102-a may identify the expected traffic arrivals according to information available via agreements (such as long term agreements) with candidate APs. The AP 102-a may select the AP 102-b from the candidate APs whose expected traffic arrivals, indicated via the agreements, are around (such as within a threshold of) the start of the TXOP. For example, the AP 102-a with an expected traffic arrival around the start of the TXOP may have a higher probability of traffic when polled by the AP 102-a, which may improve an efficiency of a multiple-AP coordination scheme (such as C-TDMA). The AP 102-a may conserve time resources by polling the AP 102-b. For example, the AP 102-b may transmit a poll response 708 to the AP 102-a indicating a lack of traffic within the TXOP. As an example, the expected traffic arrival 704 may be delayed at the AP 102-b such that the traffic may not arrive within the TXOP. The AP 102-a may, according to the poll response 708 perform a frame exchange 710 (such as via the TXOP) and terminate the TXOP 712.

In the example of FIG. 7, the AP 102-a may perform polling to avoid wasting time in examples in which the expected traffic arrival 704 is around the start of the TXOP but is delayed in accordance with jitter 716. That is, due to the jitter 716, actual traffic arrival 714 may be after termination of the TXOP. In the example in which the AP 102-b does not share the TXOP, the AP 102-b may perform channel access 718 after receiving the traffic.

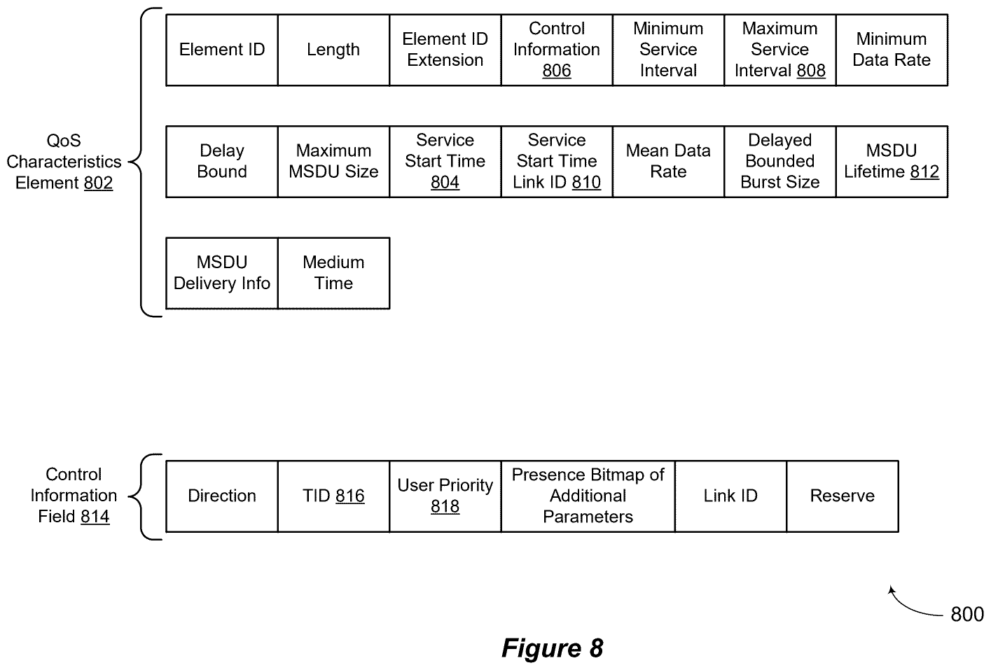

FIG. 8 shows an example of information 800 shared by wireless communication devices during an agreement phase or negotiation that supports AP selection for TXOP sharing. The information 800 of FIG. 8 may implement or be implemented to realize one or more aspects of the wireless communication network 100, the PDU 200, the PPDU 350, the wireless communication system 500, or any combination thereof. For example, the information 800 in the example of FIG. 8 may be shared between APs in a multiple-AP coordination scheme, which may be examples of the APs 102 as illustrated by and described with reference to FIGS. 1 and 5.

A sharing AP, such as the AP 102-a as described with reference to FIG. 1, may select APs to poll, select APs to share a TXOP with, or both based on expected traffic arrivals at candidate APs. In other words, a candidate AP may be polled in accordance with having an expected traffic of an access category that is at least the access category for which the TXOP is won. The expected traffic arrivals may be indicated via information shared during long-term agreements and/or negotiations. As examples, information that may be shared may be via an SCS, a traffic identifier, and/or an access category of traffic during TXOP sharing.

In examples in which the information 800 is shared via SCS, an SCS descriptor element within an SCS request may include QoS characteristics element 802, which may provide traffic characteristics and QoS characteristics (such as requirements, expectations) of traffic flows associated with an SCS stream. A service start time field 804 may indicate an anticipated time (such as in microseconds) when a traffic starts for an associated traffic identifier. For example, the service start time field may indicate a time associated with an expected traffic arrival, such as the expected traffic arrival 704 as described with reference to FIG. 7. In some examples, information of the service start time field 804 may be combined with information in other fields of the QoS characteristics element 802, such as control information 806, a maximum service interval 808, a service start time link ID 810, and/or a MAC SDU (MSDU) lifetime 812.

In another example, the information 800 may be shared via a control information field 814. For example, the control information field 814 may include a traffic identifier 816, a user priority 818, or both.

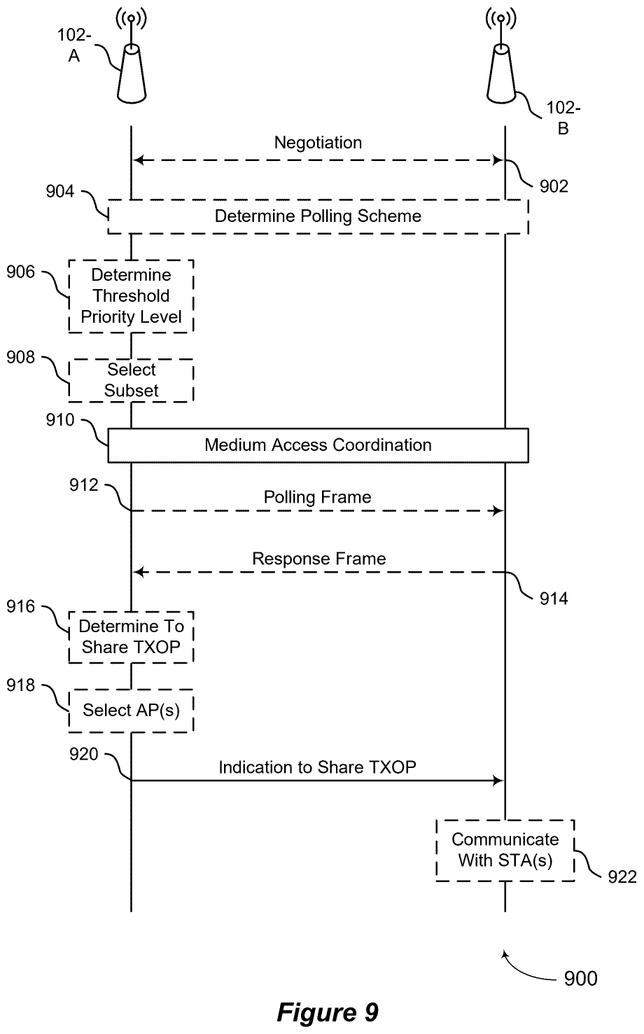

FIG. 9 shows an example of a process flow 900 that supports AP selection for TXOP sharing. The process flow may implement, or be implemented by, one or more aspects of the wireless communication network 100, the PDU 200, the PPDU 350, the wireless communication system 500, or a combination thereof. For example, the process flow 900 illustrates communication between an AP 102-a and an AP 102-b, which may be examples of corresponding devices described with reference to FIGS. 1-4.

In the following description of the process flow 900, the operations may be performed (such as reported or provided) in a different order than the order shown, or the operations performed by the example devices may be performed in different orders or at different times. For example, specific operations also may be left out of the process flow 900, or other operations may be added to the process flow 900. Further, although some operations or signaling may be shown to occur at different times for discussion purposes, these operations may actually occur at the same time.

At 902, the AP 102-a and the AP 102-b may perform negotiation. For example, the AP 102-a and the AP 102-b may be two of multiple APs in a multiple-AP coordination scheme. The AP 102-a may be an example of a sharing AP, and the AP 102-b may be an example of a shared AP. In some examples, during the negotiation, the AP 102-a and the AP 102-b may communicate information associated with establishing the multiple-AP coordination scheme. For example, the AP 102-a and/or the AP 102-b may communicate capability information (such as processing capabilities, such as associated with different polling schemes), traffic information (such as bandwidth, traffic priority, traffic flows, expected traffic), channel conditions, or the like.

At 904 the AP 102-a and the AP 102-b may determine a polling scheme. For example, the AP 102-a and the AP 102-b may determine (such as negotiate or renegotiate) a polling scheme (such as associated with the multiple-AP coordination scheme), parameters associated with polling, or both. In some examples, determining the polling scheme or the parameters associated with polling may be a part of the negotiation at 902. The polling scheme may define (such as be associated with) a polling frame and a corresponding response frame, examples of which may be described with respect to the operations at 912 and at 914. Additionally, or alternatively, the polling scheme may be associated with information including a type of response, a format of the response, a processing time associated with generating the response, a traffic type eligible for the TXOP, encoding information, an address field, or any combination thereof.

At 906, the AP 102-a may determine a threshold priority level. For example, the AP 102-a may determine a threshold priority level associated with sharing a portion of a TXOP. In other words, the AP 102-a may identify a traffic priority for which the TXOP may be used or shared. In some examples, the AP 102-a may obtain a TXOP (such as be allocated a TXOP) prior to determining the threshold priority level. For example, the threshold priority level may be in accordance with one or more characteristics of the obtained TXOP.

At 908, the AP 102-a may select a subset. For example, the AP 102-a may select a subset of candidate APs (such as or one or more other wireless communication devices) to poll. For example, the AP 102-a may determine the subset in accordance with information associated with long-term agreements between the AP 102-a and the candidate APs, stream classification service information, traffic identifiers, traffic information, or any combination thereof. In some examples, the AP 102-a may select the subset according to a polling selection scheme. As an example, the polling selection scheme may involve selecting the subset according to the information obtained or received via the negotiation at 902. For example, the AP 102-a may select the subset according to capability information (such as processing capabilities, such as associated with different polling schemes), traffic information (such as bandwidth, traffic priority, traffic flows, expected traffic), channel conditions, or the like associated with each of the candidate APs. In other words, the APs of the subset may be associated with one or more conditions for medium access within a threshold duration of a start of the TXOP. The one or more conditions may include an expected traffic arrival, one or more negotiated epochs in time, a wake state of an associated wireless communication device (such as an associated STA), an indication in a beacon or broadcast frame of a neighboring wireless communication device, or any combination thereof. In the example of FIG. 9, the AP 102-b may be one of the subset of candidate APs selected for polling.

At 910, the AP 102-a may perform medium access coordination. In some examples, the AP 102-a may perform the medium access coordination in accordance with obtaining the TXOP. The AP 102-a may perform the medium access coordination with the subset of candidate APs selected at 908, including the AP 102-b. In some examples, the medium access coordination may involve a polling frame and response frame, such as the polling frame and response frame as described with reference to the operations at 912 and 914.

At 912, the AP 102-a may transmit a polling frame to the AP 102-b. For example, the AP 102-a may transmit, during the TXOP (such as at a start of the TXOP), the polling frame. The AP 102-a may transmit the polling frame to the AP 102-b according to the polling scheme determined at 904. In examples in which the polling scheme determined at 904 is a BSRP, the AP 102-a may transmit the polling frame in accordance with the BSRP. Additionally, or alternatively, in examples in which the polling scheme includes a first frame including a poll question and a second frame, the second frame associated with a quantity of bits below a threshold quantity of bits in accordance with the poll question, the polling frame may represent the first frame.

In some examples, the polling frame may be first frame indicating respective subbands assigned to respective APs of the selected subset. For example, the polling frame may indicate a subband to be used by the AP 102-b for response frames. Additionally, or alternatively, the polling frame may be a first frame indicating respective time durations assigned to respective APs of the selected subset. For example, the polling frame may indicate a time duration during which the AP 102-b may transmit a response frame.

At 914, the AP 102-b may transmit a response frame to the AP 102-a. For example, the AP 102-b may transmit a response frame indicating one or more conditions associated with whether the AP 102-b is to participate in sharing of the portion of the TXOP. The AP 102-b may transmit the response frame to the AP 102-a according to the polling scheme determined at 904. In examples in which the polling scheme determined at 904 is a BSRP, the AP 102-b may transmit a trigger-based PPDU indicating whether the AP 102-b is to participate in sharing of the portion of the TXOP, information associated with traffic at the AP 102-b during the TXOP, or both. For example, the AP 102-b, if interested in sharing the TXOP with the AP 102-a, may include additional information in the response frame. Additionally, or alternatively, in examples in which the polling scheme includes a first frame including a poll question and a second frame, the second frame associated with a quantity of bits below a threshold quantity of bits in accordance with the poll question, the response frame may represent the second frame.

In some examples, the response frame may be a CTS frame indicating whether the AP 102-b is to participate in sharing of the portion of the TXOP, information associated with traffic at the AP 102-b during the TXOP, or both. The AP 102-b may transmit the response frame via the subband indicated in the polling frame, such as in examples in which the polling frame indicates respective subbands associated with different APs of the selected subset. Additionally, or alternatively, the AP 102-b may transmit the response frame during the time duration indicated in the polling frame, such as in examples in which the polling frame indicates the respective time durations associated with different APs of the selected subset. In some examples, the AP 102-b may indicate, via a RA in the response, whether the AP 102-b is to participate in sharing of the portion of the TXOP, information associated with traffic at the AP 102-b during the TXOP, or both. For example, the AP 102-a and the AP 102-b may determine a set of RAs and associated meanings (such as whether an AP is to participate in TXOP sharing, traffic information with respect to different ranges of traffic parameters) during the negotiation at 902, where the RA is included in the response frame at 914 according to the agreed associated meaning.

At 916, the AP 102-a may determine to share the TXOP. For example, the AP 102-a may determine to share the TXOP in accordance with traffic conditions associated with the AP 102-a, a duration of the TXOP, an expected traffic arrival of respective wireless communication devices of the subset candidate APs within the threshold duration of the start of the TXOP, or any combination thereof.

At 918, the AP 102-a may select one or more APs to share the portion of the TXOP with. For example, the AP 102-a may select the one or more APs from the selected subset of 908. In some examples, the one or more APs may satisfy the threshold priority level determined at 906. In some implementations, an AP (such as a shared AP) may indicate an intent to share the TXOP via a response frame, but not receive the shared TXOP. For example, a positive response to the polling frame at 912 may not be associated with TXOP sharing for the responsive AP.

At 920, the AP 102-a may transmit an indication to share the TXOP. For example, the AP 102-a may transmit, to the one or more selected APs including the AP 102-b, a frame including an indication to share the portion of the TXOP with the one or more selected APs. In some examples, the AP 102-a may transmit the indication to share the TXOP according to determining to share the TXOP at 916.

At 922, the AP 102-b may communicate with one or more STAs. For example, the AP 102-b may communicate with the one or more STAs in accordance with receiving the frame including the indication to share the portion of the TXOP at 920.

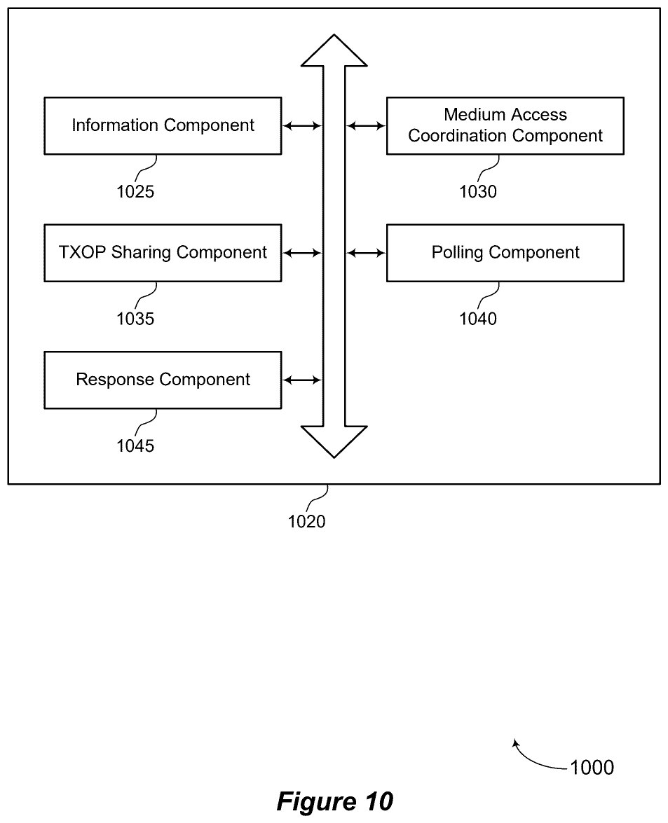

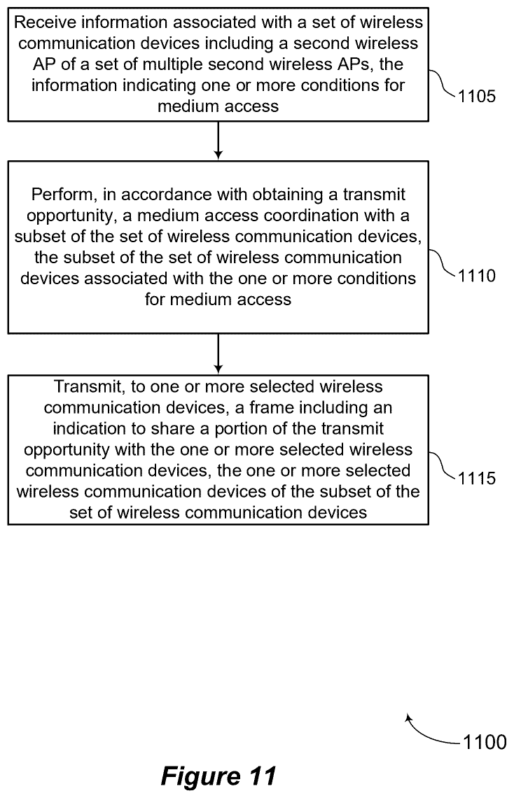

FIG. 10 shows a block diagram of an example wireless communication device 1000 that supports AP selection for TXOP sharing. In some examples, the wireless communication device 1000 is configured to perform the processes 1100, 1200, 1300, and 1400 described with reference to FIGS. 11, 12, 13, and 14, respectively. The wireless communication device 1000 may include one or more chips, SoCs, chipsets, packages, components or devices that individually or collectively constitute or include a processing system 1020. The processing system 1020 may interface with other components of the wireless communication device 1000, and may generally process information (such as inputs or signals) received from such other components and output information (such as outputs or signals) to such other components. In some aspects, an example chip may include a processing system 1020, a first interface to output or transmit information and a second interface to receive or obtain information. For example, the first interface may refer to an interface between the processing system 1020 of the chip and a transmission component, such that the wireless communication device 1000 may transmit the information output from the chip. In such an example, the second interface may refer to an interface between the processing system 1020 of the chip and a reception component, such that the wireless communication device 1000 may receive information that is then passed to the processing system 1020. In some such examples, the first interface also may obtain information, such as from the transmission component, and the second interface also may output information, such as to the reception component.

The processing system 1020 of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system 1020 may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system 1020 may further include or be coupled with one or more modems (such as a Wi-Fi (such as IEEE compliant) modem or a cellular (such as 3GPP 4G LTE, 5G or 6G compliant) modem). In some implementations, one or more processors of the processing system 1020 include or implement one or more of the modems. The processing system 1020 may further include or be coupled with multiple radios (collectively “the radio”), multiple RF chains or multiple transceivers, each of which may in turn be coupled with one or more of multiple antennas. In some implementations, one or more processors of the processing system 1020 include or implement one or more of the radios, RF chains or transceivers.

In some examples, the wireless communication device 1000 can be configurable or configured for use in an AP, such as the AP 102 described with reference to FIG. 1. In some other examples, the wireless communication device 1000 can be an AP that includes such a processing system 1020 and other components including multiple antennas. The wireless communication device 1000 is capable of transmitting and receiving wireless communication in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communication conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system 1020 that enables communication with a core network or backhaul network that enables the wireless communication device 1000 to gain access to external networks including the Internet.

The wireless communication device 1000 includes an information component 1025, a medium access coordination component 1030, a TXOP sharing component 1035, a polling component 1040, and a response component 1045. Portions of one or more of the information component 1025, the medium access coordination component 1030, the TXOP sharing component 1035, the polling component 1040, and the response component 1045 may be implemented at least in part in hardware or firmware. For example, one or more of the information component 1025, the medium access coordination component 1030, the TXOP sharing component 1035, the polling component 1040, and the response component 1045 may be implemented at least in part by at least a processor or a modem. In some examples, portions of one or more of the information component 1025, the medium access coordination component 1030, the TXOP sharing component 1035, the polling component 1040, and the response component 1045 may be implemented at least in part by a processor and software in the form of processor-executable code stored in memory.

The wireless communication device 1000 may support wireless communication in accordance with examples as disclosed herein. The information component 1025 is configurable or configured to receive information associated with a set of wireless communication devices including a second wireless AP of a set of multiple second wireless APs, the information indicating one or more criteria. The medium access coordination component 1030 is configurable or configured to perform, in accordance with obtaining a TXOP, a medium access coordination with a subset of the set of wireless communication devices, the subset of the set of wireless communication devices associated with one or more conditions for medium access within a threshold duration of a start of the TXOP. The TXOP sharing component 1035 is configurable or configured to transmit, to one or more selected wireless communication devices, a frame including an indication to share a portion of the TXOP with the one or more selected wireless communication devices, the one or more selected wireless communication devices of the subset of the set of wireless communication devices.

In some examples, the one or more conditions include an expected traffic arrival, one or more negotiated epochs in time, a wake state of an associated wireless communication device, an indication in a beacon or broadcast frame of a neighboring wireless communication device, or any combination thereof.

In some examples, to support performing the medium access coordination, the polling component 1040 is configurable or configured to transmit, during the TXOP, a polling frame. In some examples, to support performing the medium access coordination, the response component 1045 is configurable or configured to receive a response frame from at least one wireless communication device of the subset of the set of wireless communication devices, where the response frame indicates one or more conditions associated with whether the at least one wireless communication device is to participate in sharing of the portion of the TXOP.

In some examples, the TXOP sharing component 1035 is configurable or configured to determine a threshold priority level associated with sharing the portion of the TXOP, where the selected one or more wireless communication devices to share the portion of the TXOP satisfy the threshold priority level.

In some examples, transmitting the frame including the indication to share the portion of the TXOP is in accordance with determining to share the portion of the TXOP. In some examples, determining to share the portion of the TXOP in accordance with traffic conditions associated with the first wireless AP, a duration of the TXOP, an expected traffic arrival of respective wireless communication devices of the subset of the set of wireless communication devices within the threshold duration of the start of the TXOP, or any combination thereof.

In some examples, the information component 1025 is configurable or configured to determine the subset of the set of wireless communication devices in accordance with information associated with long-term agreements between the first wireless AP and the set of wireless communication devices, stream classification service information, traffic identifiers, traffic information, or any combination thereof.

In some examples, the polling component 1040 is configurable or configured to determine a polling scheme for the first wireless AP and the subset of the set of wireless communication devices, parameters associated with polling for the first wireless AP and the subset of the set of wireless communication devices, or both, where the medium access coordination is in accordance with the polling scheme, the parameters associated with polling, or both.

In some examples, to support performing the medium access coordination, the polling component 1040 is configurable or configured to transmit a polling frame. In some examples, to support performing the medium access coordination, the response component 1045 is configurable or configured to receive a trigger-based physical layer protocol data unit (PPDU) from at least one wireless communication device of the subset of the set of wireless communication devices, where the trigger-based PPDU indicates whether the at least one wireless communication device is to participate in sharing of the portion of the TXOP, information associated with traffic at the at least one wireless communication device during the TXOP, or both.

In some examples, the polling scheme includes a first frame including a poll question and a second frame, the second frame associated with a quantity of bits below a threshold quantity of bits in accordance with the poll question.

In some examples, to support performing the medium access coordination, the polling component 1040 is configurable or configured to transmit a first frame indicating respective subbands assigned to wireless communication devices of the subset of the set of wireless communication devices. In some examples, to support performing the medium access coordination, the response component 1045 is configurable or configured to receive, via a subband of the respective subbands, a CTS frame from at least one wireless communication device of the subset of the set of wireless communication devices, where the CTS frame indicates whether the at least one wireless communication device is to participate in sharing of the portion of the TXOP, information associated with traffic at the at least one wireless communication device during the TXOP, or both.

In some examples, to support performing the medium access coordination, the response component 1045 is configurable or configured to receive two or more responses from two or more wireless communication devices of the subset of the set of wireless communication devices, where the two or more responses are separated via a short inter-frame spacing.

In some examples, to support performing the medium access coordination, the response component 1045 is configurable or configured to receive a response frame from at least one wireless communication device of the subset of the set of wireless communication devices, where the response frame indicates, via a receiver address, whether the at least one wireless communication device is to participate in sharing of the portion of the TXOP, information associated with traffic at the at least one wireless communication device during the TXOP, or both.

In some examples, the information associated with the set of wireless communication devices includes a type of response, a format of the response, a processing time associated with generating the response, a traffic type eligible for the TXOP, encoding information, an address field, or any combination thereof.

Additionally, or alternatively, the wireless communication device 1000 may support wireless communication in accordance with examples as disclosed herein. In some examples, the information component 1025 is configurable or configured to transmit information indicating one or more criteria. In some examples, the medium access coordination component 1030 is configurable or configured to perform a medium access coordination with a second wireless AP in accordance with the first AP being associated with one or more conditions for medium access within a threshold duration of a start of a TXOP that is allocated to the second wireless AP. In some examples, the TXOP sharing component 1035 is configurable or configured to receive a frame from the second AP, the frame including an indication to share a portion of the TXOP that is allocated to the second wireless AP with the first wireless AP.

In some examples, the TXOP sharing component 1035 is configurable or configured to communicate with one or more wireless stations over the TXOP in accordance with receiving the frame including the indication to share the portion of the TXOP.

In some examples, the one or more conditions include an expected traffic arrival, one or more negotiated epochs in time, a wake state of an associated wireless communication device, an indication in a beacon or broadcast frame of a neighboring wireless communication device, or any combination thereof.

In some examples, to support performing the medium access coordination, the polling component 1040 is configurable or configured to receive, during the TXOP, a polling frame. In some examples, to support performing the medium access coordination, the response component 1045 is configurable or configured to transmit a response frame indicating one or more conditions associated with whether the first AP is to participate in sharing of the portion of the TXOP.

In some examples, the polling component 1040 is configurable or configured to determine a polling scheme for the first wireless AP and the second wireless AP, parameters associated with polling for the first wireless AP and the second wireless AP, or both, where the medium access coordination is in accordance with the polling scheme, the parameters associated with polling, or both.

In some examples, to support performing the medium access coordination, the polling component 1040 is configurable or configured to receive a polling frame. In some examples, to support performing the medium access coordination, the response component 1045 is configurable or configured to transmit a trigger-based physical layer protocol data unit (PPDU) indicating whether the first wireless AP is to participate in sharing of the portion of the TXOP, information associated with traffic at the first wireless AP during the TXOP, or both.

In some examples, the polling scheme includes a first frame including a poll question and a second frame, the second frame associated with a quantity of bits below a threshold quantity of bits in accordance with the poll question.

In some examples, to support performing the medium access coordination, the polling component 1040 is configurable or configured to receive a first frame indicating a subband assigned to the first wireless AP. In some examples, to support performing the medium access coordination, the response component 1045 is configurable or configured to transmit, via the subband, a CTS frame indicating whether the first wireless AP is to participate in sharing of the portion of the TXOP, information associated with traffic at the first wireless AP during the TXOP, or both.

In some examples, to support performing the medium access coordination, the response component 1045 is configurable or configured to transmit a response frame indicating, via a receiver address, whether the first wireless AP is to participate in sharing of the portion of the TXOP, information associated with traffic at the first wireless AP during the TXOP, or both.

FIG. 11 shows a flowchart illustrating an example process 1100 performable by or at a first wireless AP that supports AP selection for TXOP sharing. The operations of the process 1100 may be implemented by a first wireless AP or its components as described herein. For example, the process 1100 may be performed by a wireless communication device, such as the wireless communication device 1000 described with reference to FIG. 10, operating as or within a wireless AP. In some examples, the process 1100 may be performed by a wireless AP, such as one of the APs 102 described with reference to FIG. 1.

In some examples, in 1105, the first wireless AP may receive information associated with a set of wireless communication devices including a second wireless AP of a set of multiple second wireless APs, the information indicating one or more criteria. The operations of 1105 may be performed in accordance with examples as disclosed herein. In some implementations, aspects of the operations of 1105 may be performed by an information component 1025 as described with reference to FIG. 10.

In some examples, in 1110, the first wireless AP may perform, in accordance with obtaining a TXOP, a medium access coordination with a subset of the set of wireless communication devices, the subset of the set of wireless communication devices associated with one or more conditions for medium access within a threshold duration of a start of the TXOP. The operations of 1110 may be performed in accordance with examples as disclosed herein. In some implementations, aspects of the operations of 1110 may be performed by a medium access coordination component 1030 as described with reference to FIG. 10.

In some examples, in 1115, the first wireless AP may transmit, to one or more selected wireless communication devices, a frame including an indication to share a portion of the TXOP with the one or more selected wireless communication devices, the one or more selected wireless communication devices of the subset of the set of wireless communication devices. The operations of 1115 may be performed in accordance with examples as disclosed herein. In some implementations, aspects of the operations of 1115 may be performed by a TXOP sharing component 1035 as described with reference to FIG. 10.

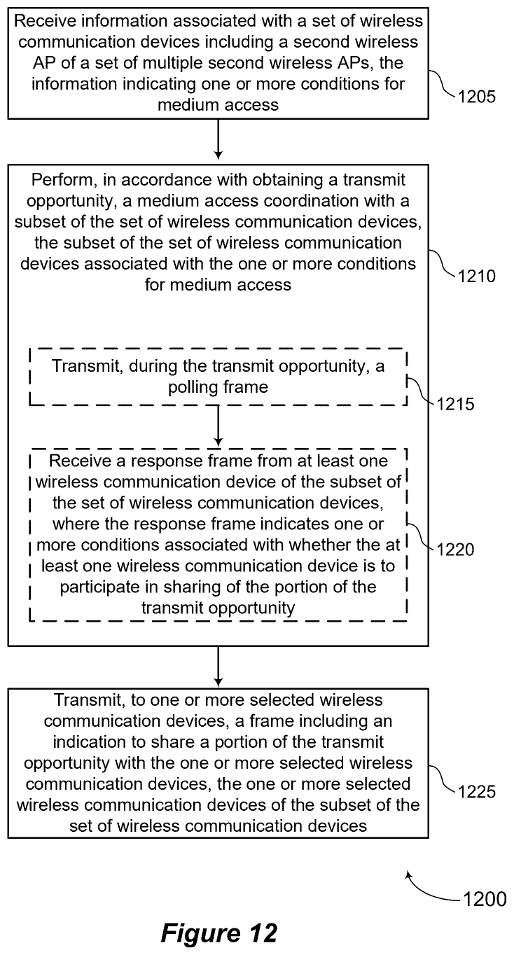

FIG. 12 shows a flowchart illustrating an example process 1200 performable by or at a first wireless AP that supports AP selection for TXOP sharing. The operations of the process 1200 may be implemented by a first wireless AP or its components as described herein. For example, the process 1200 may be performed by a wireless communication device, such as the wireless communication device 1000 described with reference to FIG. 10, operating as or within a wireless AP. In some examples, the process 1200 may be performed by a wireless AP, such as one of the APs 102 described with reference to FIG. 1.

In some examples, in 1205, the first wireless AP may receive information associated with a set of wireless communication devices including a second wireless AP of a set of multiple second wireless APs, the information indicating one or more criteria. The operations of 1205 may be performed in accordance with examples as disclosed herein. In some implementations, aspects of the operations of 1205 may be performed by an information component 1025 as described with reference to FIG. 10.

In some examples, in 1210, the first wireless AP may perform, in accordance with obtaining a TXOP, a medium access coordination with a subset of the set of wireless communication devices, the subset of the set of wireless communication devices associated with one or more conditions for medium access within a threshold duration of a start of the TXOP. The operations of 1220 may be performed in accordance with examples as disclosed herein. In some implementations, aspects of the operations of 1210 may be performed by a medium access coordination component 1030 as described with reference to FIG. 10.

In some examples, in 1215, the first wireless AP may transmit, during the TXOP, a polling frame. The operations of 1210 may be performed in accordance with examples as disclosed herein. In some implementations, aspects of the operations of 1215 may be performed by a polling component 1040 as described with reference to FIG. 10.

In some examples, in 1220, the first wireless AP may receive a response frame from at least one wireless communication device of the subset of the set of wireless communication devices, where the response frame indicates one or more conditions associated with whether the at least one wireless communication device is to participate in sharing of the portion of the TXOP. The operations of 1215 may be performed in accordance with examples as disclosed herein. In some implementations, aspects of the operations of 1220 may be performed by a response component 1045 as described with reference to FIG. 10.

In some examples, in 1225, the first wireless AP may transmit, to one or more selected wireless communication devices, a frame including an indication to share a portion of the TXOP with the one or more selected wireless communication devices, the one or more selected wireless communication devices of the subset of the set of wireless communication devices. The operations of 1225 may be performed in accordance with examples as disclosed herein. In some implementations, aspects of the operations of 1225 may be performed by a TXOP sharing component 1035 as described with reference to FIG. 10.

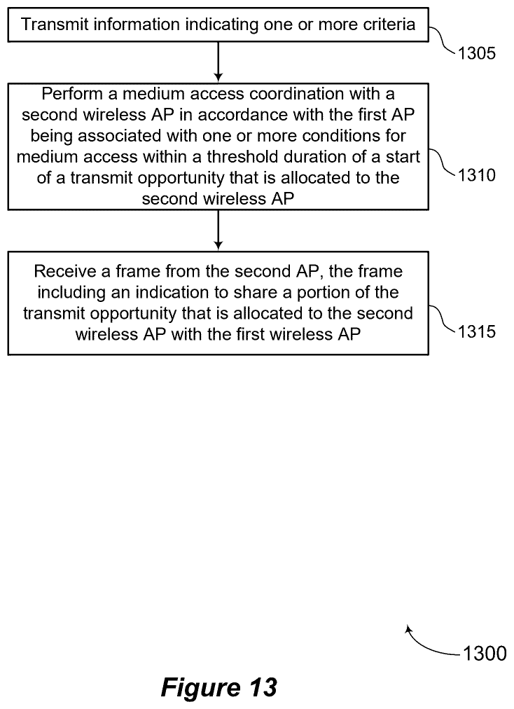

FIG. 13 shows a flowchart illustrating an example process 1300 performable by or at a first wireless AP that supports AP selection for TXOP sharing. The operations of the process 1300 may be implemented by a first wireless AP or its components as described herein. For example, the process 1300 may be performed by a wireless communication device, such as the wireless communication device 1000 described with reference to FIG. 10, operating as or within a wireless AP. In some examples, the process 1300 may be performed by a wireless AP, such as one of the APs 102 described with reference to FIG. 1.

In some examples, in 1305, the first wireless AP may transmit information indicating one or more criteria. The operations of 1305 may be performed in accordance with examples as disclosed herein. In some implementations, aspects of the operations of 1305 may be performed by an information component 1025 as described with reference to FIG. 10.

In some examples, in 1310, the first wireless AP may perform a medium access coordination with a second wireless AP in accordance with the first AP being associated with one or more conditions for medium access within a threshold duration of a start of a TXOP that is allocated to the second wireless AP. The operations of 1310 may be performed in accordance with examples as disclosed herein. In some implementations, aspects of the operations of 1310 may be performed by a medium access coordination component 1030 as described with reference to FIG. 10.

In some examples, in 1315, the first wireless AP may receive a frame from the second AP, the frame including an indication to share a portion of the TXOP that is allocated to the second wireless AP with the first wireless AP. The operations of 1315 may be performed in accordance with examples as disclosed herein. In some implementations, aspects of the operations of 1315 may be performed by a TXOP sharing component 1035 as described with reference to FIG. 10.

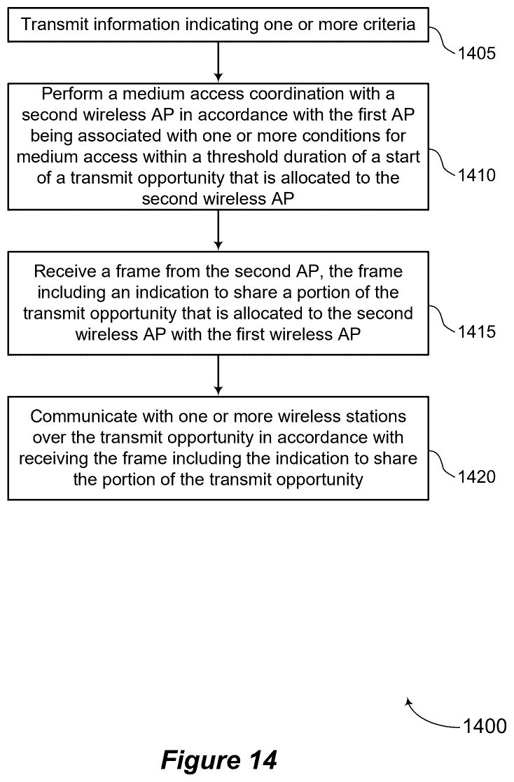

FIG. 14 shows a flowchart illustrating an example process 1400 performable by or at a first wireless AP that supports AP selection for TXOP sharing. The operations of the process 1400 may be implemented by a first wireless AP or its components as described herein. For example, the process 1400 may be performed by a wireless communication device, such as the wireless communication device 1000 described with reference to FIG. 10, operating as or within a wireless AP. In some examples, the process 1400 may be performed by a wireless AP, such as one of the APs 102 described with reference to FIG. 1.

In some examples, in 1405, the first wireless AP may transmit information indicating one or more criteria. The operations of 1405 may be performed in accordance with examples as disclosed herein. In some implementations, aspects of the operations of 1405 may be performed by an information component 1025 as described with reference to FIG. 10.

In some examples, in 1410, the first wireless AP may perform a medium access coordination with a second wireless AP in accordance with the first AP being associated with one or more conditions for medium access within a threshold duration of a start of a TXOP that is allocated to the second wireless AP. The operations of 1410 may be performed in accordance with examples as disclosed herein. In some implementations, aspects of the operations of 1410 may be performed by a medium access coordination component 1030 as described with reference to FIG. 10.

In some examples, in 1415, the first wireless AP may receive a frame from the second AP, the frame including an indication to share a portion of the TXOP that is allocated to the second wireless AP with the first wireless AP. The operations of 1415 may be performed in accordance with examples as disclosed herein. In some implementations, aspects of the operations of 1415 may be performed by a TXOP sharing component 1035 as described with reference to FIG. 10.

In some examples, in 1420, the first wireless AP may communicate with one or more wireless stations over the TXOP in accordance with receiving the frame including the indication to share the portion of the TXOP. The operations of 1420 may be performed in accordance with examples as disclosed herein. In some implementations, aspects of the operations of 1420 may be performed by a TXOP sharing component 1035 as described with reference to FIG. 10.

Implementation examples are described in the following numbered aspects:

Aspect 1: A method by a first wireless AP, comprising: a processing system that includes processor circuitry and memory circuitry that stores code, the processing system configured to cause the first wireless AP to: receiving information associated with a set of wireless communication devices comprising a second wireless AP of a plurality of second wireless APs, the information indicating one or more conditions for medium access; performing, in accordance with obtaining a transmit opportunity, a medium access coordination with a subset of the set of wireless communication devices, the subset of the set of wireless communication devices associated with the one or more conditions for medium access; and transmitting, to one or more selected wireless communication devices, a frame comprising an indication to share a portion of the transmit opportunity with the one or more selected wireless communication devices, the one or more selected wireless communication devices of the subset of the set of wireless communication devices.

Aspect 2: The method of aspect 1, wherein the one or more conditions comprise an expected traffic arrival, one or more negotiated epochs in time, a wake state of an associated wireless communication device, an indication in a beacon or broadcast frame of a neighboring wireless communication device, or any combination thereof.

Aspect 3: The method of any of aspects 1 through 2, wherein performing the medium access coordination comprises: transmitting, during the transmit opportunity, a polling frame; and receiving a response frame from at least one wireless communication device of the subset of the set of wireless communication devices, wherein the response frame indicates one or more conditions associated with whether the at least one wireless communication device is to participate in sharing of the portion of the transmit opportunity.

Aspect 4: The method of any of aspects 1 through 3, wherein performing the medium access coordination comprises: receiving an unsolicited resource request frame from at least one wireless communication device of the subset of the set of wireless communication devices, wherein the unsolicited resource request frame indicates a pending buffer size, a time-to-live, a bandwidth-time product, or any combination of, associated with the at least one wireless communication device.

Aspect 5: The method of any of aspects 1 through 4, further comprising: the processing system is further configured to cause the first wireless AP to determine a threshold priority level associated with sharing the portion of the transmit opportunity, the selecting one or more wireless communication devices to share the portion of the transmit opportunity satisfy the threshold priority level.

Aspect 6: The method of any of aspects 1 through 5, wherein transmitting the frame comprising the indication to share the portion of the transmit opportunity is in accordance with determining to share the portion of the transmit opportunity, and determining to share the portion of the transmit opportunity in accordance with traffic conditions associated with the first wireless AP, a duration of the transmit opportunity, an expected traffic arrival of respective wireless communication devices of the subset of the set of wireless communication devices within a threshold duration of a start of the transmit opportunity, or any combination thereof.

Aspect 7: The method of any of aspects 1 through 6, further comprising: the processing system is further configured to cause the first wireless AP to determine the subset of the set of wireless communication devices in accordance with information associated with long-term agreements between the first wireless AP and the set of wireless communication devices, stream classification service information, traffic identifiers, traffic information, or any combination thereof.

Aspect 8: The method of aspect 7, wherein receiving the information associated with the set of wireless communication devices comprises: receiving the information associated with long-term agreements via a Wi-Fi link or a backhaul link.

Aspect 9: The method of any of aspects 7 through 8, wherein a traffic identifier, a user priority, a minimum service interval, a maximum service interval, a service start time, a service start time link identifier, a medium access control (MAC) service data unit (MSDU) lifetime, or any combination thereof.

Aspect 10: The method of any of aspects 1 through 9, further comprising: the processing system is further configured to cause the first wireless AP to determine a polling scheme for the first wireless AP and the subset of the set of wireless communication devices, parameters associated with polling for the first wireless AP and the subset of the set of wireless communication devices, or both, the medium access coordination being in accordance with the polling scheme, the parameters associated with polling, or both.

Aspect 11: The method of aspect 10, wherein performing the medium access coordination comprises: transmitting a polling frame; and receiving a trigger-based physical layer protocol data unit (PPDU) from at least one wireless communication device of the subset of the set of wireless communication devices, wherein the trigger-based PPDU indicates whether the at least one wireless communication device is to participate in sharing of the portion of the transmit opportunity, information associated with traffic at the at least one wireless communication device during the transmit opportunity, or both.

Aspect 12: The method of any of aspects 10 through 11, wherein performing the medium access coordination comprises: receiving signaling from at least one second wireless communication device of the subset of the set of wireless communication devices, wherein the signaling indicates whether the at least one second wireless communication device supports the polling scheme for the first wireless AP.

Aspect 13: The method of any of aspects 10 through 12, wherein the polling scheme comprises a first frame including a poll question and a second frame, the second frame associated with a quantity of bits below a threshold quantity of bits in accordance with the poll question.

Aspect 14: The method of any of aspects 10 through 13, wherein performing the medium access coordination comprises: transmitting a first frame indicating respective subbands assigned to wireless communication devices of the subset of the set of wireless communication devices; and receiving, via a subband of the respective subbands, a CTS frame from at least one wireless communication device of the subset of the set of wireless communication devices, wherein the CTS frame indicates whether the at least one wireless communication device is to participate in sharing of the portion of the transmit opportunity, information associated with traffic at the at least one wireless communication device during the transmit opportunity, or both.

Aspect 15: The method of any of aspects 10 through 14, wherein performing the medium access coordination comprises: receiving two or more responses from two or more wireless communication devices of the subset of the set of wireless communication devices, wherein the two or more responses are separated via a short inter-frame spacing.

Aspect 16: The method of any of aspects 10 through 15, wherein performing the medium access coordination comprises: receiving a response frame from at least one wireless communication device of the subset of the set of wireless communication devices, wherein the response frame indicates, via a receiver address, whether the at least one wireless communication device is to participate in sharing of the portion of the transmit opportunity, information associated with traffic at the at least one wireless communication device during the transmit opportunity, or both.

Aspect 17: The method of any of aspects 1 through 16, wherein the information associated with the set of wireless communication devices comprises a type of response, a format of the response, a processing time associated with generating the response, a traffic type eligible for the transmit opportunity, encoding information, an address field, or any combination thereof.

Aspect 18: The method of any of aspects 1 through 17, wherein the medium access coordination is in accordance with one or more multiple-AP coordination schemes, the one or more multiple-AP coordination schemes including a coordinated time-division multiple access scheme, a coordinated spatial reuse scheme, a coordinated beamforming scheme, a coordinated spatial reuse scheme, a coordinated-restricted target wake time scheme, or any combination thereof.

Aspect 19: A first wireless AP comprising a processing system that includes processor circuitry and memory circuitry that stores code, the processing system configured to cause the first wireless AP to perform a method of any of aspects 1 through 18.

Aspect 20: A first wireless AP comprising at least one means for performing a method of any of aspects 1 through 18.

Aspect 21: A non-transitory computer-readable medium storing code the code comprising instructions executable by one or more processors to perform a method of any of aspects 1 through 18.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,”’ or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless access point (AP), comprising:
a processing system that includes processor circuitry and memory circuitry that stores code, the processing system configured to cause the first wireless AP to:
receive information associated with a set of wireless communication devices comprising a second wireless AP of a plurality of second wireless APs, the information indicating one or more conditions for medium access;
perform, in accordance with obtaining a transmit opportunity, a medium access coordination with a subset of the set of wireless communication devices, the subset of the set of wireless communication devices associated with the one or more conditions for medium access; and
transmit, to one or more selected wireless communication devices, a frame comprising an indication to share a portion of the transmit opportunity with the one or more selected wireless communication devices, the one or more selected wireless communication devices of the subset of the set of wireless communication devices.

2. The first wireless AP of claim 1, wherein the one or more conditions comprise an expected traffic arrival, one or more negotiated epochs in time, a wake state of an associated wireless communication device, an indication in a beacon or broadcast frame of a neighboring wireless communication device, or any combination thereof.

3. The first wireless AP of claim 1, wherein, to perform the medium access coordination, the processing system is configured to cause the first wireless AP to:
transmit, during the transmit opportunity, a polling frame; and
receive a response frame from at least one wireless communication device of the subset of the set of wireless communication devices, wherein the response frame indicates one or more conditions associated with whether the at least one wireless communication device is to participate in sharing of the portion of the transmit opportunity.

4. The first wireless AP of claim 1, wherein, to perform the medium access coordination, the processing system is configured to cause the first wireless AP to:
receive an unsolicited resource request frame from at least one wireless communication device of the subset of the set of wireless communication devices, wherein the unsolicited resource request frame indicates a pending buffer size, a time-to-live, a bandwidth-time product, or any combination of, associated with the at least one wireless communication device.

5. The first wireless AP of claim 1, wherein the processing system is further configured to cause the first wireless AP to determine a threshold priority level associated with sharing the portion of the transmit opportunity, wherein the selected one or more wireless communication devices to share the portion of the transmit opportunity satisfy the threshold priority level.

6. The first wireless AP of claim 1, wherein:
transmitting the frame comprising the indication to share the portion of the transmit opportunity is in accordance with determining to share the portion of the transmit opportunity, and
determining to share the portion of the transmit opportunity in accordance with traffic conditions associated with the first wireless AP, a duration of the transmit opportunity, an expected traffic arrival of respective wireless communication devices of the subset of the set of wireless communication devices within a threshold duration of a start of the transmit opportunity, or any combination thereof.

7. The first wireless AP of claim 1, wherein the processing system is further configured to cause the first wireless AP to determine the subset of the set of wireless communication devices in accordance with information associated with long-term agreements between the first wireless AP and the set of wireless communication devices, stream classification service information, traffic identifiers, traffic information, or any combination thereof.

8. The first wireless AP of claim 7, wherein the information associated with the set of wireless communication devices is received via a Wi-Fi link or a backhaul link.

9. The first wireless AP of claim 7, wherein the information associated with long-term agreements between the first wireless AP and the set of wireless communication devices comprises a traffic identifier, a user priority, a minimum service interval, a maximum service interval, a service start time, a service start time link identifier, a medium access control (MAC) service data unit (MSDU) lifetime, or any combination thereof.

10. The first wireless AP of claim 1, wherein the processing system is further configured to cause the first wireless AP to determine a polling scheme for the first wireless AP and the subset of the set of wireless communication devices, parameters associated with polling for the first wireless AP and the subset of the set of wireless communication devices, or both, wherein the medium access coordination is in accordance with the polling scheme, the parameters associated with polling, or both.

11. The first wireless AP of claim 10, wherein, to perform the medium access coordination, the processing system is configured to cause the first wireless AP to:
transmit a polling frame; and
receive a trigger-based physical layer protocol data unit (PPDU) from at least one wireless communication device of the subset of the set of wireless communication devices, wherein the trigger-based PPDU indicates whether the at least one wireless communication device is to participate in sharing of the portion of the transmit opportunity, information associated with traffic at the at least one wireless communication device during the transmit opportunity, or both.

12. The first wireless AP of claim 10, wherein, to perform the medium access coordination, the processing system is configured to cause the first wireless AP to:
receive signaling from at least one second wireless communication device of the subset of the set of wireless communication devices, wherein the signaling indicates whether the at least one second wireless communication device supports the polling scheme for the first wireless AP.

13. The first wireless AP of claim 10, wherein the polling scheme comprises a first frame including a poll question and a second frame, the second frame associated with a quantity of bits below a threshold quantity of bits in accordance with the poll question.

14. The first wireless AP of claim 10, wherein, to perform the medium access coordination, the processing system is configured to cause the first wireless AP to:
transmit a first frame indicating respective subbands assigned to wireless communication devices of the subset of the set of wireless communication devices; and
receive, via a subband of the respective subbands, a clear to send (CTS) frame from at least one wireless communication device of the subset of the set of wireless communication devices, wherein the CTS frame indicates whether the at least one wireless communication device is to participate in sharing of the portion of the transmit opportunity, information associated with traffic at the at least one wireless communication device during the transmit opportunity, or both.

15. The first wireless AP of claim 10, wherein, to perform the medium access coordination, the processing system is configured to cause the first wireless AP to:
receive two or more responses from two or more wireless communication devices of the subset of the set of wireless communication devices, wherein the two or more responses are separated via a short inter-frame spacing.

16. The first wireless AP of claim 10, wherein, to perform the medium access coordination, the processing system is configured to cause the first wireless AP to:
receive a response frame from at least one wireless communication device of the subset of the set of wireless communication devices, wherein the response frame indicates, via a receiver address, whether the at least one wireless communication device is to participate in sharing of the portion of the transmit opportunity, information associated with traffic at the at least one wireless communication device during the transmit opportunity, or both.

17. The first wireless AP of claim 1, wherein the information associated with the set of wireless communication devices comprises a type of response, a format of the response, a processing time associated with generating the response, a traffic type eligible for the transmit opportunity, encoding information, an address field, or any combination thereof.

18. The first wireless AP of claim 1, wherein the medium access coordination is in accordance with one or more multiple-AP coordination schemes, the one or more multiple-AP coordination schemes including a coordinated time-division multiple access scheme, a coordinated spatial reuse scheme, a coordinated beamforming scheme, a coordinated spatial reuse scheme, a coordinated-restricted target wake time scheme, or any combination thereof.

19. A method for wireless communication at a first wireless access point (AP), comprising:
receiving information associated with a set of wireless communication devices comprising a second wireless AP of a plurality of second wireless APs, the information indicating one or more conditions for medium access;
performing, in accordance with obtaining a transmit opportunity, a medium access coordination with a subset of the set of wireless communication devices, the subset of the set of wireless communication devices associated with the one or more conditions for medium access; and
transmitting, to one or more selected wireless communication devices, a frame comprising an indication to share a portion of the transmit opportunity with the one or more selected wireless communication devices, the one or more selected wireless communication devices of the subset of the set of wireless communication devices.

20. The method of claim 19, wherein performing the medium access coordination further comprises:
transmitting, during the transmit opportunity, a polling frame; and
receiving a response frame from at least one wireless communication device of the subset of the set of wireless communication devices, wherein the response frame indicates one or more conditions associated with whether the at least one wireless communication device is to participate in sharing of the portion of the transmit opportunity.
